(19) United States
(12) Patent Application Publication
(10) Pub. No.: US 2023/0410239 A1
(43) Pub. Date: Dec. 21, 2023

(54) Proportional control systems and methods for innovation cross-subsidies

(71) Applicant: Sin Ying Barbara Fok, Hong Kong (HK)

(72) Inventor: Sin Ying Barbara Fok, Hong Kong (HK)

(21) Appl. No.: 17/844,008

(22) Filed: Jun. 19, 2022

(51) Int. Cl. G06Q 50/26; G06Q 10/04

(52) U.S. Cl. CPC G06Q 50/265; G06Q 10/04

(57) ABSTRACT

A current best recipe having a particular environmental benefit is entitled to collecting licensing income from corporate partners, and the online innovation cross-subsidization obtains environmental impact values from innovative recipes using statistical analysis, and determines a current best recipe from among the innovative recipes on an ongoing basis by (i) providing a statistical analysis to the one or more gaps for selecting from available environmental benefits, (ii) receiving from the statistical analysis, environmental impact values in relation to selected environmental benefits of the available environmental benefits, (iii) tracking, for the selected environmental benefits, gap reductions based at least in part on the environmental impact values, and (iv) using at least the gap reductions to determine a current best environmental impact value for a particular environmental benefit and determining, among the one or more environmental benefits indicated by the gap data, which environmental benefits have best recipes.

### FIELD OF THE INVENTION

One or more embodiments of the invention relate generally to innovation cross-subsidies and more particularly, for example, to systems and methods for control for environmental impact values.

### BACKGROUND OF THE INVENTION

Market environmentalism is a significant feature of the retail environment. The most obvious have been the largely superficial rebranding of products with green symbols to give their commodities some ecological window-dressing. Free markets allow for the production of dissenting communities and distinctive modes of production, so long as they can survive in a free market environment. They either forgo some profit for more expensive ecologically responsible production, or find customers who share green preferences and will pay extra for the product to support the environmental or environmental goal. Some entrepreneurial vegan food artisans operate in just such a way. However, these are not without substantial problems. Business people often find it hard to integrate ecological thinking into their conceptual framework, who tend to reinterpret green concerns into financial calculation. Even in ecological businesses, there are going to be times when ecological issues come into conflict with profit maximization. It may be that the enterprise will choose to reduce profit, in which case it is no longer operating as a corporation; alternatively, it relegates environmental values as secondary to exchange values, thereby making green principles secondary to achieving profitable goals.

Innovation cross-subsidies provide local, independent, and small-scale vegan food artisans the required conditions for survival in the free market at large. Innovative food artisans create positive environmental change for an environmental purpose while financial capital provided from corporate partners are directed as subsidies of that innovation. The technology disclosed herein provides systems and methods for applying commercial strategies to maximize improvements in financial, environmental and environmental well-being, which include maximizing environmental impact alongside profits for co-owners, strategically identifying innovation and opportunistically exploiting subsidies of that innovation. The technology disclosed makes active use of licensing, royalties, etc, to direct revenue generated from external corporate partners to support the cost for internal ecological partners, searches actively for innovation cross-subsidies and creates environmental capital as valuable as financial capital. Innovative recipes are classified in an environmental impact category, and distributed by environmental impact category to food artisans both within and outside of the community. Purposive inflows and outflows of knowledge are used to accelerate internal innovation and expand the markets for external use of innovation. Protocols are established for environmental food artisans to release any newly created innovations into the open source community for licensing recipes. Cross-subsidies is a deliberately designed market mechanism for mitigating risk, which is to be calculated with reference to the category-wise cost of innovation. Entrepreneurial innovators are driven by the desire to collaboratively create robust communities that interactively solve one another's development problems. All groupings, even if they operate internally on different principles such as cooperation that gains benefit from something through use, but not having private ownership, have to interact with each other at least initially on the principles of market distribution and exchange. Ecological food artisans sell anything that a typical business offers, at prices driven by environmental purpose rather than market-determined price signals created by forces of supply and demand. The technology disclosed provides ways for corporate partners to provide subsidies to the best innovative recipes wherein the subsidy amount is tied to impact values of the innovation.

### SUMMARY OF THE INVENTION

The technology disclosed provides a commercialization controller that transfers from corporate partner licensing income to best innovative recipes produced by an ecological food artisan network wherein proportional control is performed to tie the licensing income amount to environmental impact values of the innovation. Feedback control senses the environmental impact outputs and feeds it back so that adjustments can be made to the level of licensing income accordingly. The network operates in support of a farm-to-boardroom initiative characterized by directing licensing income obtained from the innovative recipes as cross-subsidies of the plurality of environmental impact values indicated by one or more gaps between a current impact value and a target impact value of the initiative.

It is a reasonable estimate that applying financial capital input to a first order transfer function at any level long enough will result in a constant output rate that corresponds to that level, in which case the outputs are innovation capital and environmental capital produced by the network. Applying a little more financial capital and the output of more innovation capital and environmental capital will increase the overall environmental impact value of the initiative a little faster. If financial capital input is applied slowly and the overall environmental impact value of the initiative will change slowly according to the level of the financial capital input. Therefore the gaps can be adjusted in such a way that the financial capital causes the initiative to eventually reach its target impact value, while having the licensing income from corporate partners to stay relatively constant.

A reference impact value, i.e. a desired impact value or the ultimate goal, is compared to a measured impact value to arrive at a delta from the reference impact value, which is the gap between the initiative's starting impact value to the desired impact value, and the initiative's current impact value, which is measured by the initiative. The commercialization controller adjusts the gap in such a way that the input into the initiative causes it to eventually reach its target impact value. The gap is taken and analyzed and then displays to the operator. As time progresses, the gap is driven to zero, which means the measured environmental impact value is exactly where it wants to be, and thus the community meets all of its requirements.

In some embodiments, the technology disclosed includes modeling a Boolean network of the production practices and environmental benefits previously stored in the database from a single dataset or datasets that pertains to a single ecological food artisan. A Boolean network may include a number of discrete binary variables—such as ecological food artisan production practices, characteristics, or environmental benefits—that are interrelated via Boolean functions that define dependencies of some variables upon others. In other embodiments, neural networks or other machine learning techniques or predictive algorithms may be used. An online innovation cross-subsidization classifies environmental impact values for collecting licensing income from the identified corporate partner supportive towards a gap, and provides a statistical analysis to the initiative gaps for selecting current best recipes from among the available innovative recipes on an ongoing basis. A current best recipe for a particular environmental benefit is entitled to collecting licensing income from the corporate partner supportive towards an initiative gap.

### BRIEF DESCRIPTION OF THE DRAWINGS

FIG. 1A illustrates a flow chart of one example embodiment for determining a recipe between one or more production practices of ecological food artisans and one or more environmental benefits of the ecological food artisan based on a statistical analysis of the production practices and environmental benefits.

FIG. 1B illustrates a flow chart according to one alternative embodiment for determining a recipe between one or more production practices of ecological food artisans and one or more environmental benefits of the ecological food artisan based on a statistical analysis of the production practices and environmental benefits.

FIG. 1C illustrates a flow chart according to another alternative embodiment of a method for determining a recipe between one or more production practices of ecological food artisans and one or more environmental benefits of the ecological food artisan based on a statistical analysis of the production practices and environmental benefits.

FIG. 2 illustrates implementations of collecting one or more targeted subsidies from corporate partners, according to various embodiments of the present disclosure.

FIG. 3A illustrates a farm-to-boardroom initiative having an ecological food artisan network in an example of the invention.

FIG. 3B illustrates a process for assigning innovative recipes of environmental impact values to asset storage systems in an example of the invention.

FIG. 4 illustrates a GUI for assessing environmental capital gaps in an example of the invention.

FIG. 5 illustrates a GUI for assessing innovation gaps in an example of the invention.

FIG. 6 illustrates a GUI for providing information for the farm-to-boardroom initiative in an example of the invention.

FIG. 7 illustrates a GUI for providing information for the farm-to-boardroom initiative in an example of the invention.

FIG. 8 illustrates a GUI for providing information for the farm-to-boardroom initiative in an example of the invention.

### DETAILED DESCRIPTION OF THE INVENTION

The technology disclosed provides a commercialization controller that transfers from corporate partner licensing income to best innovative recipes produced by an ecological food artisan network wherein proportional control is performed to tie the licensing income amount to environmental impact values of the innovation. Feedback control senses the environmental impact outputs and feeds it back so that adjustments can be made to the level of licensing income accordingly. The network operates in support of a farm-to-boardroom initiative characterized by directing licensing income obtained from the innovative recipes as cross-subsidies of the plurality of environmental impact values indicated by one or more gaps between a current impact value and a target impact value of the initiative.

It is a reasonable estimate that applying financial capital input to a first order transfer function at any level long enough will result in a constant output rate that corresponds to that level, in which case the outputs are innovation capital and environmental capital produced by the network. Applying a little more financial capital and the output of more innovation capital and environmental capital will increase the overall environmental impact value of the initiative a little faster. If financial capital input is applied slowly and the overall environmental impact value of the initiative will change slowly according to the level of the financial capital input. Therefore the gaps can be adjusted in such a way that the financial capital causes the initiative to eventually reach its target impact value, while having the licensing income from corporate partners to stay relatively constant.

A reference impact value, i.e. a desired impact value or the ultimate goal, is compared to a measured impact value to arrive at a delta from the reference impact value, which is the gap between the initiative's starting impact value to the desired impact value, and the initiative's current impact value, which is measured by the initiative. The commercialization controller adjusts the gap in such a way that the input into the initiative causes it to eventually reach its target impact value. The gap is taken and analyzed and then displays to the operator. As time progresses, the gap is driven to zero, which means the measured environmental impact value is exactly where it wants to be, and thus the community meets all of its requirements.

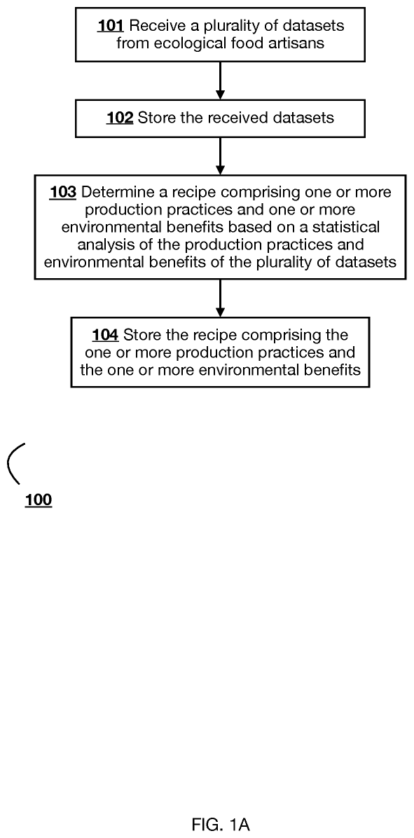

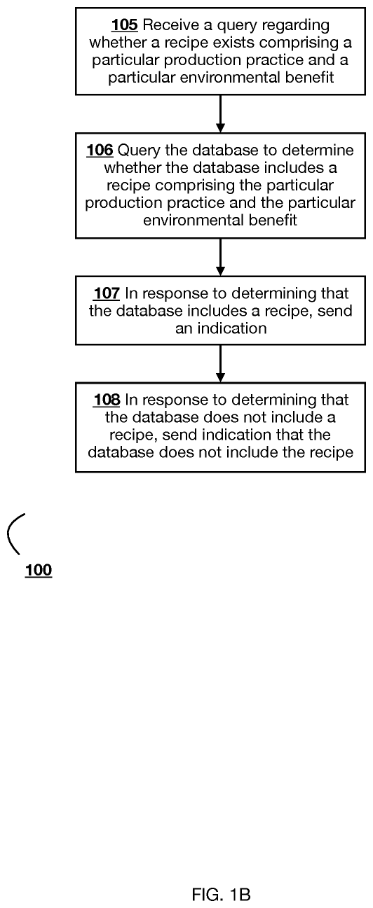

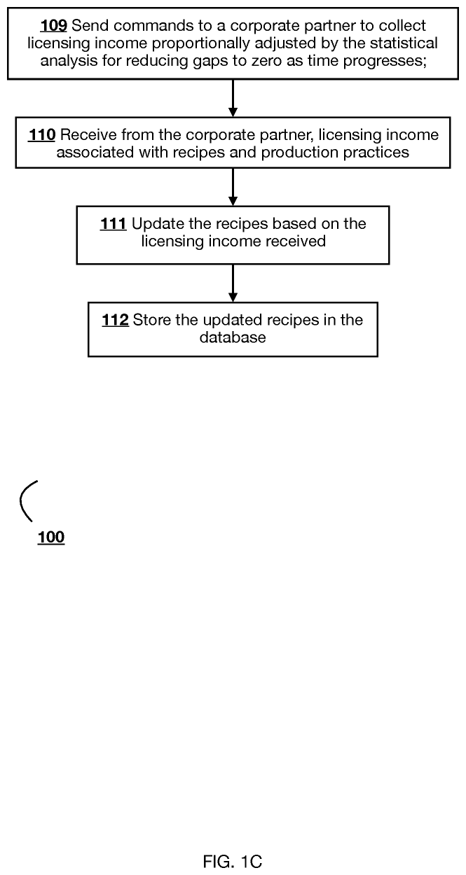

FIG. 1A illustrates a method 100 for creating a predictive model of an outcome, according to example embodiments.

First, at step 101, the method includes receiving, at a computing device, a plurality of datasets from a corresponding plurality of ecological food artisans. In some embodiments, the method may include receiving a single dataset pertaining to one ecological food artisan or a plurality of datasets pertaining to that one ecological food artisan. Each ecological food artisan has at least one corresponding environmental benefit, and an individual dataset for an individual ecological food artisan may include information about at least one environmental benefit of the individual ecological food artisan and at least one production practice of the individual ecological food artisan.

The environmental benefit of each ecological food artisan may be any currently known environmental benefit. In some circumstances the environmental benefit may be a new and previously unknown environmental benefit. The production practice may be any production practice that may influence or affect the environmental condition of the ecological food artisan and could be a new and previously unknown production practice. For example, the production practice may include using 1) natural cruelty-free practices, 2) no-till practices when possible, 3) never using any pesticides, herbicides or fungicides, 4) using organic seeds and fertilizers, or 5) integrated pest management.

After the datasets are received, the process then proceeds to step 102. At step 102, the received datasets are stored in a database comprising a tangible, non-transitory computer readable media.

In preferred embodiments, the computing device receives datasets from a plurality of ecological food artisans over varying timeframes, e.g., days, weeks, months, or even years. Preferably, the plurality of ecological food artisans includes a statistically significant number of ecological food artisans from which to determine recipes comprising ecological food artisan production practices and environmental benefits (and in some cases, recipes comprising ecological food artisan production practices, environmental benefits, and ecological food artisan characteristics). But, in some embodiments, the recipe may be generated for a single ecological food artisan based on a dataset including only that ecological food artisan's past production practices, environmental purposes and/or characteristics. However, preferably, the plurality of ecological food artisans is quite large, such as on the order of a few thousand to tens of thousands. However, a smaller plurality of ecological food artisans could be used with a corresponding reduction in confidence levels corresponding to determined recipes.

The database may be a relational database or any other type of database. The database may include other information about each of the ecological food artisans. For example, the database may include ecological food artisan characteristics comprising a profile for the ecological food artisan including, for example, artisanal crafts, food sales, production volume, locally sourced ingredients, environmental impact history, or other characteristics of the ecological food artisan. The database may also store more or less information regarding the current environmental impact value of each ecological food artisan. For example, the database may include information regarding the value of the environmental benefit or a detailed description of the environmental benefit. Other information that is relevant to the medical background of the ecological food artisan may be included as well.

Once the data has been stored, at step 103, a recipe comprising one or more production practices and one or more environmental benefits may be determined based on a statistical analysis of the production practices and environmental benefits of the plurality of datasets received from the corresponding plurality of ecological food artisans. In some embodiments, the method may include determining a recipe comprising one or more production practices and one or more environmental benefits included in a single dataset that pertains to a single ecological food artisan.

In an example embodiment, determining the recipe comprising one or more production practices and one or more environmental benefits of an environmental benefit based on a statistical analysis of the production practices and environmental benefits of the plurality of datasets received from the corresponding plurality of ecological food artisans may include modeling a Boolean network of the production practices and environmental benefits previously stored in the database at step 102, for example. In some embodiments, the method may include modeling a Boolean network of the production practices and environmental benefits previously stored in the database from a single dataset or datasets that pertains to a single ecological food artisan. A Boolean network may include a number of discrete binary variables—such as ecological food artisan production practices, characteristics, or environmental benefits—that are interrelated via Boolean functions that define dependencies of some variables upon others. In other embodiments, neural networks or other machine learning techniques or predictive algorithms may be used to determine a recipe comprising ecological food artisan production practices and environmental benefits.

After the recipe has been determined, at step 104, the recipe comprising the particular production practice and the at least one environmental benefit may be stored in the database. The recipe may be stored in a manner similar to the datasets discussed above with reference to step 102, for example. In one instance, the recipe is stored in a manner that associates the recipe with the relevant ecological food artisans.

In preferred embodiments, the recipe is based on a plurality of ecological food artisan datasets collected from ecological food artisan data received from a plurality of ecological food artisans over time. Thus, the recipe determined at step 104 may be based upon an analysis of data aggregated from many hundreds, thousands, or even millions of ecological food artisan datasets. However, in other embodiments the recipe may be based on a dataset or datasets collected from a limited number of ecological food artisans (even a single ecological food artisan in some instances.)

Additionally, recipes comprising specific ecological food artisan production practices and environmental benefits may be stored in the database. In operation, each recipe may have a confidence factor or similar assessment corresponding to the strength of the recipe comprising the production practice and its effect on a environmental benefit.

FIG. 1B shows another example embodiment of additional or alternative steps of the method 100 shown in FIG. 1A. In FIG. 1B, the method additionally includes steps 105-108. At step 105, the computing device may receive a query regarding whether a recipe exists comprising a particular production practice and a particular environmental benefit.

In response to receiving the query, at step 105, the computing device may query the database to determine whether the database includes a recipe comprising the particular production practice and the particular environmental benefit for the particular environmental benefit. The particular production practice and particular environmental benefit may be any of the environmental benefits and production practices discussed above with regard to steps 100-104.

In response to determining that the database includes a recipe comprising the particular production practice and the particular environmental benefit, the computing device may send an indication of the recipe, and in response to determining that the database does not include a recipe comprising the particular production practice and the particular environmental benefit, the computing device may send an indication that the database does not include a recipe comprising the particular production practice and the particular environmental benefit.

FIG. 10 shows an even further example embodiment of additional or alternative steps of the method shown in FIG. 1A. In FIG. 10, the method additionally includes steps 109-112. At step 109, the computing device may further be configured to send commands to at least one corporate partner to collect licensing income associated with one or more recipes comprising a specific production practice, wherein the licensing income is directly proportional to cost parameters of the production practice. The statistical analysis proportionally adjusts the licensing income for reducing the one or more gaps to zero as time progresses, and the specific production practice may be selected to provide a predicted amount of environmental benefit towards reducing one or more gaps between a current initiative and a target initiative in accordance with a particular recipe stored in the database.

Once the licensing income associated with the performance of the specific production practice of the at least one corporate partners and at least one environmental benefit of the environmental benefit of the ecological food artisan have been received, the amount of subsidies available to ecological food artisans using the particular recipe may be updated based on the licensing revenue received from the at least one corporate partners, and any updates may be stored in the database. In some embodiments, a new recipe may be made based on the licensing revenue received from the ecological food artisan.

In operation, if one ecological food artisan performs a production practice that improves one of that ecological food artisan's environmental benefits, then the system may advise other ecological food artisans to perform that same production practice to determine whether and the extent to which that production practice improves the same environmental benefit in the other ecological food artisans, thereby collecting data to verify or disprove a potential recipe. For example, in some embodiments, once the system recognizes a potential recipe comprising a particular production practice and a certain environmental benefit, the system may instruct additional ecological food artisans to perform that particular production practice for the purpose of collecting further data from the additional ecological food artisans who perform the particular production practice.

If the further data collected from the additional ecological food artisans does not establish a sufficient statistical recipe comprising the particular production practice and an improvement in the environmental benefit, then the system may conclude that the particular production practice and the environmental benefit condition are not statistically correlated, thus disproving the potential recipe. But if the further data collected from the additional ecological food artisans corroborates the potential recipe, then the system may instruct even more ecological food artisans to perform that particular production practice to obtain sufficient data to determine that a recipe exists comprising the particular production practice and the environmental benefit.

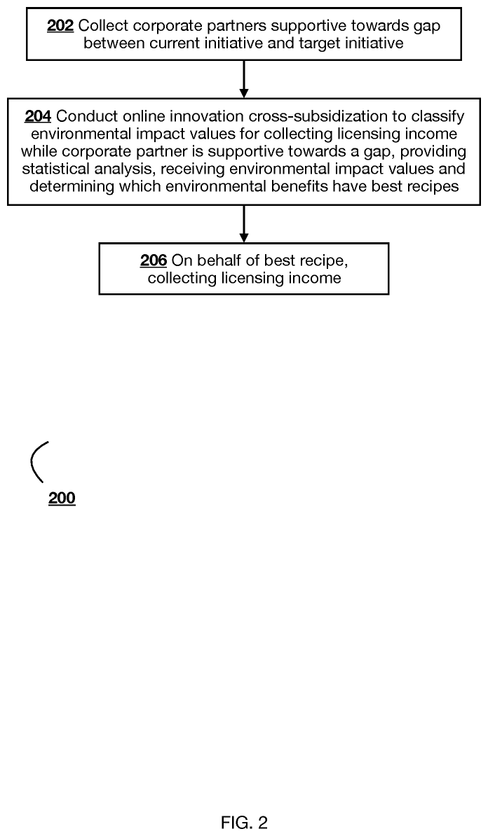

Referring to FIG. 2, a flowchart 200 including various operations is illustrated to describe a process of collecting one or more target licensing income from a corporate partner. This process of collecting the licensing income from the corporate partner is performed using identification information (e.g., membership card information) and environmental benefit information that is promoted while the corporate partner is currently supportive towards a gap.

In operation 202 the process collects a corporate partner's identification and promotes benefits from the gap. Specifically, operation 202 may include, for example, collecting gap data from numerous gaps in databases, the gap data identifying the corporate partner using a unique identification and identifying one or more benefits promoted while the identified corporate partner is supportive towards one of the gaps.

In operation 204 the process conducts an online innovation cross-subsidization to classify environmental impact values for collecting licensing income from the identified corporate partner supportive towards a gap by providing a statistical analysis, collecting licensing revenue and determining which benefits have best recipes. More specifically, operation 204 may include, for example, conducting an online innovation cross-subsidization to collect licensing income, by environmental benefit or a group of benefits, for collecting licensing income from the identified corporate partner triggered by promotion of an environmental benefit or benefits in the databases, in which best predicted effects, if any, are determined as of the time the corporate partner is supportive towards the gap.

Referring to operation 204, in an implementation, a current best recipe for a particular environmental benefit is entitled to collecting licensing income from the corporate partner supportive towards a gap, and/or collect licensing income from the identified corporate partner, and the online innovation cross-subsidization obtains environmental impact values from recipes using statistical analysis, and determines the current best recipe from among the innovative recipes on an ongoing basis by performing the following:

Providing a statistical analysis to the initiative gaps for selecting from environmental benefits that are available through the online innovation cross-subsidization; receiving from the statistical analysis, environmental impact values in relation to selected environmental benefits of the available environmental benefits, as well as, for example, effective dates, and subsidy descriptions that include subsidy values; tracking, for the selected environmental benefits, gap reductions based at least in part on the environmental impact values in relation to the selected environmental benefits; and while the identified corporate partner remains supportive towards the target initiative gap, using at least the gap reductions to determine a current best environmental impact value for a particular environmental benefit and determining, among the one or more environmental benefits indicated by the gap data, which environmental benefits have best recipes.

In operation 206 the process includes, on behalf of best recipe and, for example, responsive to an election by the best recipe, promoting the best recipe's environmental values by collecting a licensing income from the corporate partner supportive towards the gap. Specifically, operation 206 may include, for example, on behalf of a best recipe, promoting the best recipe's environmental values by collecting licensing income from the corporate partner supportive towards gap reduction.

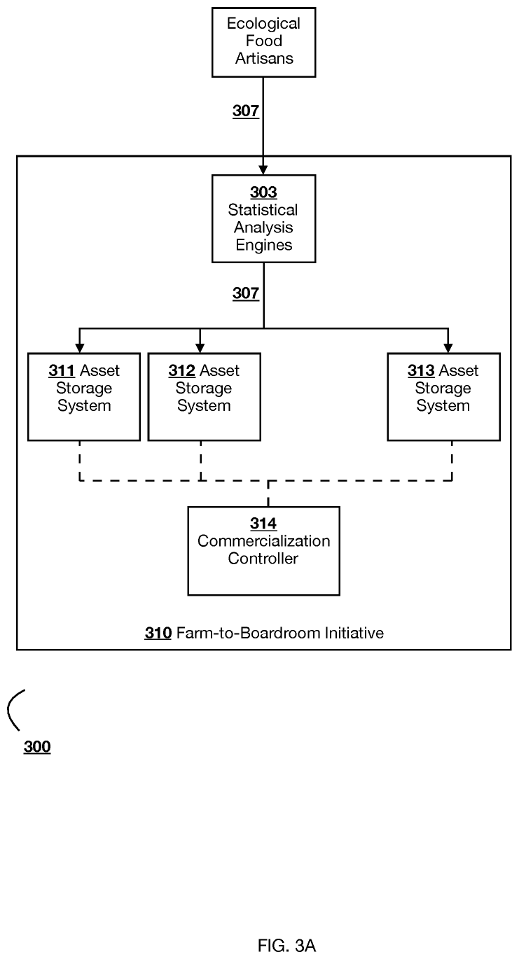

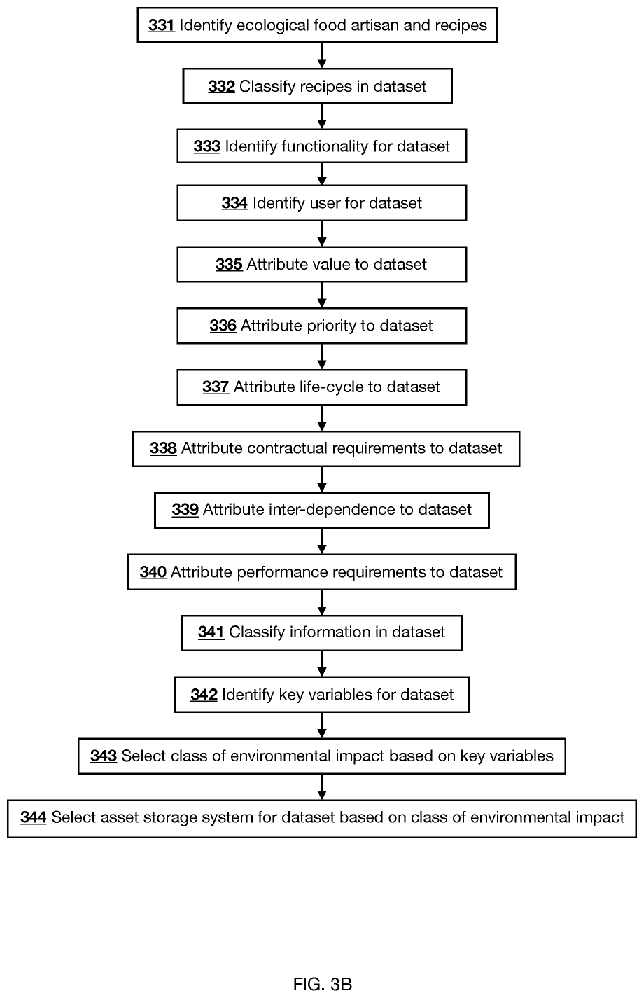

FIGS. 3A and 3B illustrate an ecological food artisan network 300 and the operation of commercialization controller 314 included in the network 300 when assigning an application recipe to an asset storage management system in an example of the invention.

To determine the assignment, the recipe is first analyzed to determine various factors for the recipe. Commercialization controller 314 starts the process by identifying an ecological food artisan and by identifying the recipes for the artisan (331). Typically, network personnel will identify ecological food artisan and their recipes to the operator for entry into commercialization controller 314. An ecological food artisan is any member in network 300 that provides datasets 307. The datasets 307 for the ecological food artisan can be separated into identifiable recipes of environmental impact values. A single ecological food artisan can have one recipe or multiple recipes. For example, the ecological food artisan could have an environmental impact resulting from individual recipes for artisanal crafts, food sales, production volume, and locally sourced ingredients.

For a given recipe, commercialization controller 314 classifies the data in the recipe (332).

For a classified recipe, commercialization controller 314 identifies a functionality for the recipe (333). The functionality represents the environmental purpose of the recipe.

For a given recipe, commercialization controller 314 identifies a user for the recipe (334). The user represents the entity in network 300 that needs the environmental impact from the recipe.

For a given recipe, commercialization controller 314 attributes a value to the recipe (335). The value represents a monetary value of the recipe to network 300.

Commercialization controller 314 attributes a priority to the recipe (336). The priority represents the importance of the recipe to network 300 in terms of environmental capital supplies, financial capital supplies, and innovation capital supplies.

Commercialization controller 314 attributes a life-cycle to the recipe (337). The life-cycle represents a time period during which the recipe retains value to network 300.

Commercialization controller 314 attributes contractual requirements to the recipe (338). The contractual requirements indicate if the recipe needs to be kept for legal purposes.

Commercialization controller 314 attributes inter-dependencies to the recipe (339). The inter-dependencies indicate other corporate partners that are dependent on the current recipe.

Commercialization controller 314 attributes performance requirements to the recipe (340). The performance requirements indicate any specific industry-recognized performance metrics that are in relation to the recipe.

For a given recipe, commercialization controller 314 classifies the information represented by the data (341).

The above factors are data class, functionality, user, value, priority, life-cycle, contractual requirements, inter-dependencies, performance, and information class. As noted, the factors that commercialization controller 314 makes available for selection are controlled and consistent. Each factor that is available for selection has a corresponding score.

For the recipe, a set of key variables is assessed to determine compatibility between the recipe and the various classes of environmental impact (342). In this example the classes of environmental impact are: extremely critical, mission critical, and business critical, although different classes-of-environmental impact could be used.

To assess the key variables for the recipe, commercialization controller 314 selects the class of environmental impact for the recipe based on the key variables (343). For example, once the variables are selected for the recipe, commercialization controller 314 compares the recipe variables against the class-of-environmental impact variables to determine which classes-of-environmental impact are suitable for the recipe. For example, both the extremely critical and mission critical classes-of-environmental impact may be suitable for a given recipe.

For the recipe, commercialization controller 314 selects an asset storage system based on the selected class of environmental impact (344). Typically, each class-of-environmental impact is pre-assigned to an asset storage system. New asset storage systems and classes-of-environmental impact may be implemented over time.

In some examples, commercialization controller 314 may transfer control messages indicating the selected asset storage system for the recipe to the selected asset storage systems 311-313 and to statistical analysis engine 303. In response to the control messages, statistical analysis engine 303 routes the recipe to the selected asset storage systems, and the selected asset storage systems store the data and provide the various features available to the recipe.

Commercialization controller 314 manages environmental capital, financial capital, and innovation capital of farm-to-boardroom initiative for an ecological food artisan community in some examples of the invention. To accomplish this task, commercialization controller 314 interacts with an operator through its GUI to develop a current and future view of the environmental capital, financial capital, and innovation capital for farm-to-boardroom initiative 310. Advantageously, commercialization controller 314 requires the operator to apply a rigorous and detailed analysis to accurately identify the gaps between the current state and a desired future state for farm-to-boardroom initiative 310 at the environmental capital, financial capital, and innovation capital levels.

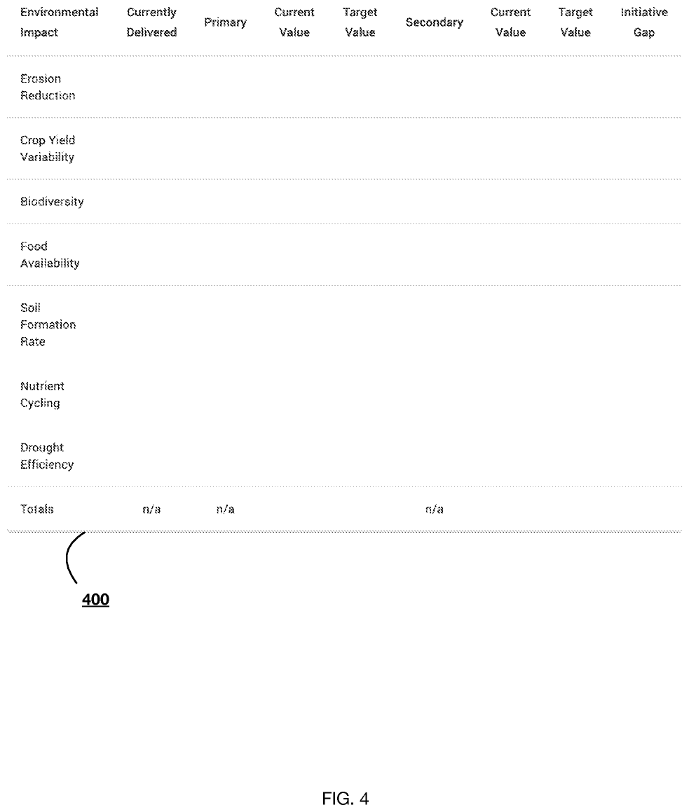

FIG. 4 illustrates GUI 400 that is provided by commercialization controller 314 to manage environmental capital. The left column of GUI 400 lists various environmental impacts that are provided by environmental capital.

The top row of GUI 400 includes several categories to prompt operator input or indicate management system output.

For any environmental impacts that are currently being delivered, commercialization controller 314 uses GUI 400 to obtain the current environmental impact values that the primary food artisan and any secondary food artisans provide using innovative services. For each environmental impact, commercialization controller 314 uses GUI 400 to obtain the targeted environmental impact values that the primary food artisan and any secondary food artisans should provide using innovative services.

On a per-environmental impact basis, commercialization controller 314 totals the current environmental impact values for the primary and secondary food artisans and totals the targeted environmental impact values for the primary and secondary food artisans. On a per-environmental impact basis, commercialization controller 314 subtracts the total of targeted environmental impact values from the total for current environmental impact values to identify the initiative gap for that environmental impact. Commercialization controller 314 automatically indicates the gaps on a per-environmental impact basis in the right column of GUI 400.

For all environmental impacts, commercialization controller 314 totals the current environmental impact values for the primary and secondary food artisans and totals the targeted environmental impact values for the primary and secondary food artisans. Commercialization controller 314 subtracts the total of targeted environmental impact values (for all environmental impacts) from the total for current environmental impact values (for all environmental impacts) to identify the gap for all environmental impacts. Commercialization controller 314 automatically indicates the gap for all environmental impacts at the right in the bottom row of GUI 400.

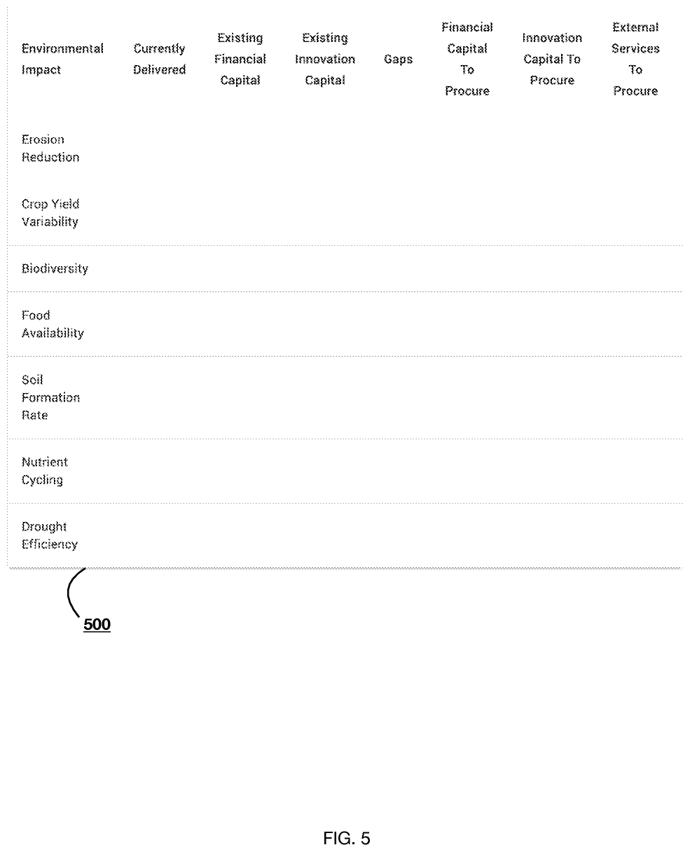

FIG. 5 illustrates GUI 500 that is provided by commercialization controller 314 to manage cross-subsidization. The left column of GUI 900 lists various environmental impacts that are provided by farm-to-boardroom initiative environmental capital and described above for FIG. 4. The top row of GUI 500 includes several categories to prompt operator input or indicate management system output.

For each environmental impact, commercialization controller 314 obtains the existing financial capital, innovation capital, and external environmental impacts from the operator in the applicable columns on GUI 500. For each environmental impact, commercialization controller 314 indicates the environmental capital gaps developed in GUI 400. Like the GUI operations depicted above, the operator may position the GUI cursor over a given field, and a drop down menu box appears with the various items for selection. The operator may position the cursor over the selection for automatic entry of the selection into the field.

For each environmental impact, commercialization controller 314 uses GUI 500 to obtain from the operator the financial capital, innovation capital, and external environmental impacts to be procured and to obtain the time of the procurement. When making a purchasing decision for an environmental impact, the operator can view the existing cross-subsidization (financial capital, innovation capitals, external environmental impacts) used to deliver the environmental impact, and the operator can also view the environmental capital gaps for the environmental impact. Advantageously, commercialization controller 314 enables cross-subsidization decisions to be made that close these gaps. Thus, cross-subsidization is used to reduce initiative gaps and to improve overall initiative.

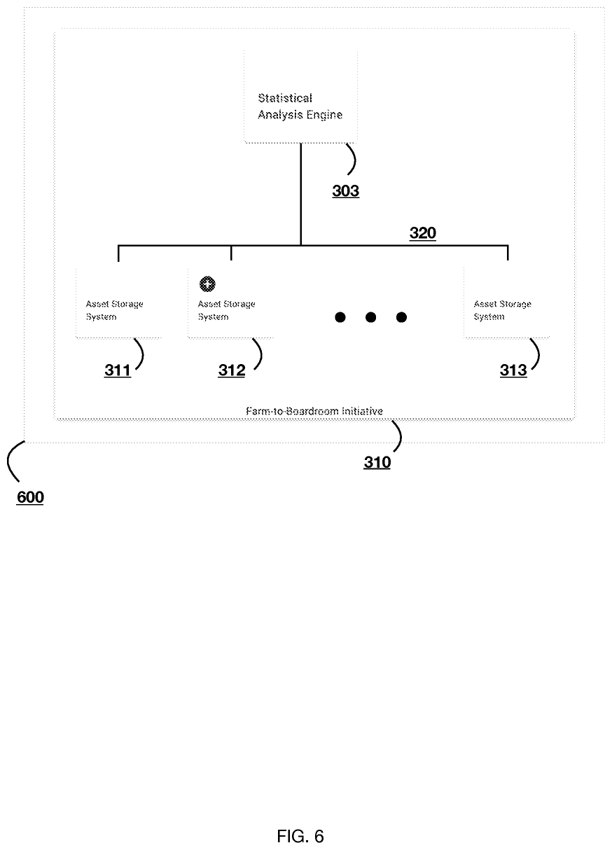

FIGS. 6-8 illustrate GUI 600 that is provided by commercialization controller 314 to manage inventory. GUI 600 depicts a block diagram of farm-to-boardroom initiative 310 that includes statistical analysis engine 303, asset storage systems 311-313, and network 320. The GUI operator may select one of these elements, such as by clicking the element with a mouse, and GUI 600 depicts the selected element in further detail. This operator selection process can continue until desired product or status information is provided.

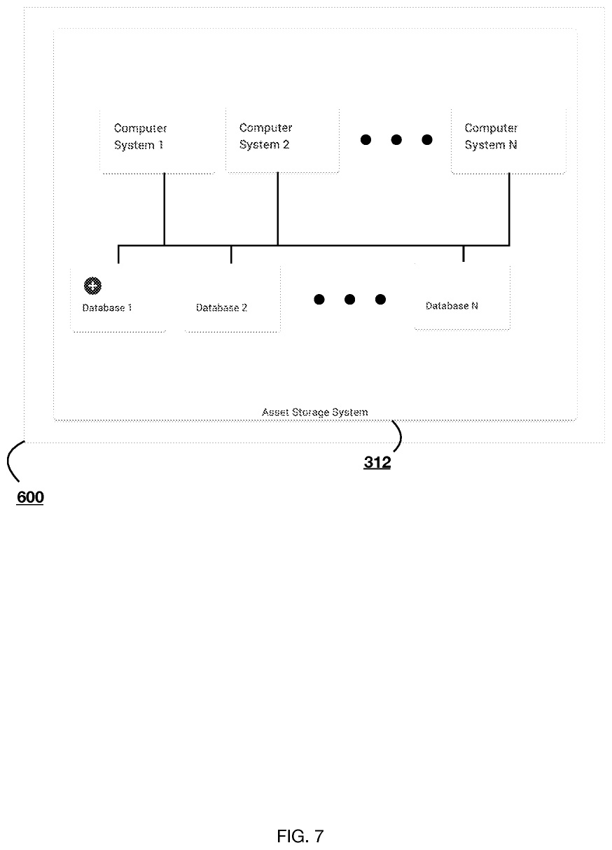

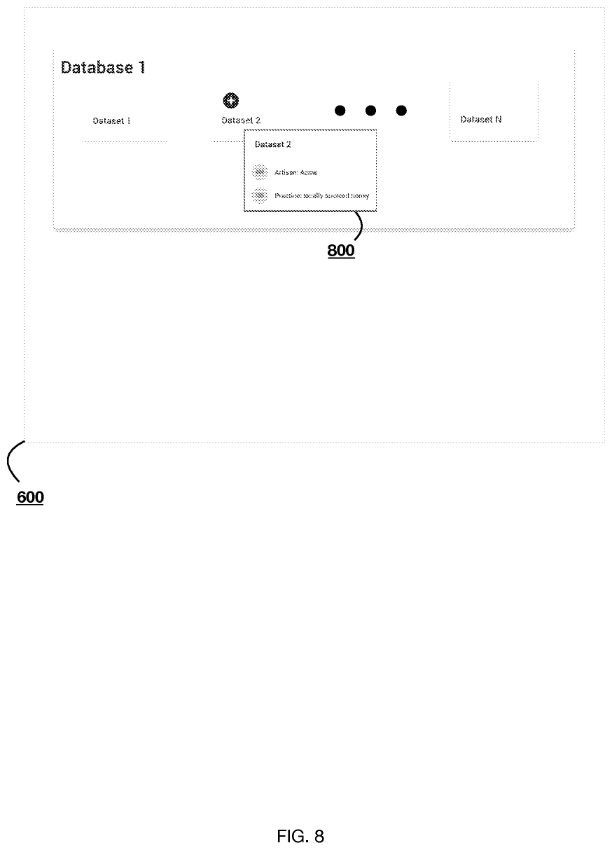

For example, the GUI operator may select asset storage system 312 as indicated by the “+” mark on FIG. 6. In response to the selection of asset storage system 312, GUI 600 depicts asset storage system 312 in further detail as shown in FIG. 7. On FIG. 7, GUI 600 shows asset storage system 312 as having computer systems 1-N and databases 1-N. The GUI operator may then select database 1 as indicated by the “+” mark on FIG. 7. In response to the selection of database 1, GUI 600 depicts database 1 in further detail as shown in FIG. 8. On FIG. 8, GUI 600 shows database 1 as having datasets 1-N. The GUI operator may finally select dataset 2 as indicated by the “+” mark on FIG. 8. In response to the selection of dataset 2, GUI 600 depicts product and status information for dataset 2 in an information box 800 as shown in FIG. 8.

1. A method of operating a farm-to-boardroom initiative for an ecological food artisan network that produces innovative recipes of environmental impact values, characterized by directing licensing income obtained from the innovative recipes as cross-subsidies of the environmental impact values indicated by reference gaps between a current initiative and a target initiative, wherein the reference gaps are driven to zero as time progresses by adjusting the licensing income accordingly on an ongoing basis, the method comprising:
receiving, at a computing device, a dataset from an ecological food artisan, wherein the dataset includes information about at least one environmental benefit supported by the ecological food artisan and at least one production practice used by the ecological food artisan, wherein the at least one production practice includes at least one of (i) using natural cruelty-free practices, (ii) no-till practices when possible, (iii) never using any pesticides, herbicides, or fungicides, (iv) using organic seeds and fertilizers, or (v) integrated pest management;
storing the dataset in a database comprising a tangible, non-transitory computer readable media, wherein the database includes a profile for the ecological food artisan comprising one or more of artisanal crafts, food sales, production volume, locally sourced ingredients, and environmental impact history of the ecological food artisan;
in a plurality of asset storage systems in communication with a plurality of statistical analysis engines, storing the plurality of environmental impact values, wherein the asset storage systems are comprised of databases and wherein the databases are comprised of the dataset;
in a commercialization controller, displaying a first graphical view of the current initiative including the statistical analysis engines, and the asset storage systems;
in the commercialization controller, receiving a first user input selecting, from the first graphical view, one of the asset storage systems of the first graphical view, and in response to the first user input, displaying a second graphical view of the databases in the selected asset storage system; and
in the commercialization controller, determining and displaying a gap, wherein the gap comprises an environmental capital gap, a financial capital gap, and an innovation capital gap, and the environmental capital gap indicates a difference between current environmental impact values and targeted environmental impact values for a primary food artisan and a secondary food artisan, wherein the primary food artisan comprises a main food artisan that provides an innovative service, and the secondary food artisan comprises a support food artisan that assists in providing the innovative service;
determining a recipe comprising one or more production practices and one or more environmental benefits based on a statistical analysis of the production practices and environmental benefits included in the dataset, wherein the statistical analysis comprises using a Boolean network to model the production practices and environmental benefits stored in the database;
storing in the database the recipe comprising the one or more production practices and the one or more environmental benefits;
receiving a query regarding whether a particular recipe exists comprising a particular production practice and a particular environmental benefit;
in response to receiving the query, querying the database to determine whether the database includes the particular recipe comprising the particular production practice and the particular environmental benefit;
sending an indication of whether the database includes the particular recipe comprising the particular production practice and the particular environmental benefit;
sending commands to a corporate partner to collect the licensing income associated with the particular recipe stored in the database, wherein the statistical analysis proportionally adjusts the licensing income for reducing the reference gaps to zero as time progresses;
receiving, from the corporate partner, licensing income associated with the specific production practice;
updating, based on the received licensing income, subsidies available to ecological food artisans supporting one or more environmental impact values indicated by the gap;
storing the available subsides in association with the one or more environmental impact values in the database;
conducting an online innovation cross-subsidization to classify the one or more environmental impact values, by an environmental benefit or a group of environmental benefits, for collecting licensing income from the corporate partner triggered by promotion of an environmental benefit or benefits in the database, in which best environmental impact values, if any, are determined as of the time the corporate partner is supportive towards the gap, wherein:
a current best recipe having a particular environmental benefit is entitled to collecting licensing income from the corporate partner; and
the online innovation cross-subsidization obtains environmental impact values from the innovative recipes using the statistical analysis, and determines the current best recipe from among the innovative recipes on an ongoing basis by:
providing the statistical analysis to the reference gaps for selecting from environmental benefits that are available through the online innovation cross-subsidization;
receiving from the statistical analysis, environmental impact values in relation to selected environmental benefits of the available environmental benefits;
tracking, for the selected environmental benefits, gap reductions based at least in part on the environmental impact values in relation to the selected environmental benefits; and
while the corporate partner remains supportive towards the gap, using at least the gap reductions to determine a current best environmental impact value for a particular environmental benefit and determining, among the one or more environmental benefits indicated by the gap data, which environmental benefits have best recipes.

2. The method of claim 1, wherein the plurality of asset storage systems further comprise computer systems, and wherein displaying the second graphical view comprises displaying the second graphical view including the computer systems in the selected asset storage system.

3. The method of claim 1, wherein the statistical analysis further comprises using a neural network.

4. The method of claim 1, wherein the statistical analysis further comprises using a machine learning technique.

5. The method of claim 1, wherein the statistical analysis further comprises using a predictive algorithm.

6. A farm-to-boardroom initiative system for an ecological food artisan network that produces innovative recipes of environmental impact values, characterized by directing licensing income obtained from the innovative recipes as cross-subsidies of the environmental impact values indicated by reference gaps between a current initiative and a target initiative, wherein the reference gaps are driven to zero as time progresses by adjusting the licensing income accordingly on an ongoing basis, the system comprising:
one or more processors configured to
receive, at a computing device, a dataset from an ecological food artisan, wherein the dataset includes information about at least one environmental benefit supported by the ecological food artisan and at least one production practice used by the ecological food artisan, wherein the at least one production practice includes at least one of (i) using natural cruelty-free practices, (ii) no-till practices when possible, (iii) never using any pesticides, herbicides, or fungicides, (iv) using organic seeds and fertilizers, or (v) integrated pest management;
store the dataset in a database comprising a tangible, non-transitory computer readable media, wherein the database includes a profile for the ecological food artisan comprising one or more of artisanal crafts, food sales, production volume, locally sourced ingredients, and environmental impact history of the ecological food artisan;
in a plurality of asset storage systems in communication with a plurality of statistical analysis engines, store the plurality of environmental impact values, wherein the asset storage systems are comprised of databases and wherein the databases are comprised of the dataset;
in a commercialization controller, display a first graphical view of the current initiative including the statistical analysis engines, and the asset storage systems;
in the commercialization controller, receive a first user input selecting, from the first graphical view, one of the asset storage systems of the first graphical view, and in response to the first user input, displaying a second graphical view of the databases in the selected asset storage system; and
in the commercialization controller, determine and display a gap, wherein the gap comprises an environmental capital gap, a financial capital gap, and an innovation capital gap, and the environmental capital gap indicates a difference between current environmental impact values and targeted environmental impact values for a primary food artisan and a secondary food artisan, wherein the primary food artisan comprises a main food artisan that provides an innovative service, and the secondary food artisan comprises a support food artisan that assists in providing the innovative service;
determine a recipe comprising one or more production practices and one or more environmental benefits based on a statistical analysis of the production practices and environmental benefits included in the dataset, wherein the statistical analysis comprises using a Boolean network to model the production practices and environmental benefits stored in the database;
store in the database the recipe comprising the one or more production practices and the one or more environmental benefits;
receive a query regarding whether a particular recipe exists comprising a particular production practice and a particular environmental benefit;
in response to receiving the query, query the database to determine whether the database includes the particular recipe comprising the particular production practice and the particular environmental benefit;
send an indication of whether the database includes the particular recipe comprising the particular production practice and the particular environmental benefit;
send commands to a corporate partner to collect the licensing income associated with the particular recipe stored in the database, wherein the statistical analysis proportionally adjusts the licensing income for reducing the reference gaps to zero as time progresses;
receive, from the corporate partner, licensing income associated with the specific production practice;
update, based on the received licensing income, subsidies available to ecological food artisans supporting one or more environmental impact values indicated by the gap;
store the available subsides in association with the one or more environmental impact values in the database;
conduct an online innovation cross-subsidization to classify the one or more environmental impact values, by an environmental benefit or a group of environmental benefits, for collecting licensing income from the corporate partner triggered by promotion of an environmental benefit or benefits in the database, in which best environmental impact values, if any, are determined as of the time the corporate partner is supportive towards the gap, wherein:
a current best recipe having a particular environmental benefit is entitled to collecting licensing income from the corporate partner; and
the online innovation cross-subsidization obtains environmental impact values from the innovative recipes using the statistical analysis, and determines the current best recipe from among the innovative recipes on an ongoing basis by:
providing the statistical analysis to the reference gaps for selecting from environmental benefits that are available through the online innovation cross-subsidization;
receiving from the statistical analysis, environmental impact values in relation to selected environmental benefits of the available environmental benefits;
tracking, for the selected environmental benefits, gap reductions based at least in part on the environmental impact values in relation to the selected environmental benefits; and
while the corporate partner remains supportive towards the gap, using at least the gap reductions to determine a current best environmental impact value for a particular environmental benefit and determining, among the one or more environmental benefits indicated by the gap data, which environmental benefits have best recipes.

7. The system of claim 6, wherein the plurality of asset storage systems further comprise computer systems, and wherein displaying the second graphical view comprises displaying the second graphical view including the computer systems in the selected asset storage system.

8. The system of claim 6, wherein the statistical analysis further comprises using a neural network.

9. The system of claim 6, wherein the statistical analysis further comprises using a machine learning technique.

10. The system of claim 6, wherein the statistical analysis further comprises using a predictive algorithm.
